(19) United States
(12) Patent Application Publication
(10) Pub. No.: US 2024/0075542 A1
(43) Pub. Date: Mar. 7, 2024

(54) Circular Cutting Tools With Polycrystalline Diamond Composite (PDC) Cutting Bits

(71) Applicants: George J. FISHER, Hornsby Heights, NSW (AU); ECHIDNA USA, LLC, Jackson, LA (US)

(72) Inventor: George J. Fischer, Hornsby Heights, NSW (AU)

(21) Appl. No.: 17/766,971

(22) PCT Filed: Oct. 8, 2020
(86) PCT No.: PCT/US2020/054746

§ 371 Date: Apr. 6, 2022

Related U.S. Application Data
(60) Provisional application No. 62/914,800, filed on Oct. 14, 2019.

(51) Int. Cl. B23C 5/06; B23C 5/22

(52) U.S. Cl. CPC B23C 5/06; B23C 5/2278; B23C 2200/045; B23C 2226/315

(57) ABSTRACT

A cutting tool has a circular core with a plurality of bit holder pockets arranged around its periphery. Bit holders are positioned within the bit holder pockets and held in place by fastening wedges, which are in turn threadably engaged with wedge anchors. A cutting bit, which may be a polycrystalline diamond composite (PDC) cutting bit, is mounted on each bit holder. Removal of the fastening wedges permits easy removal and placement of the bit holders with attached bits.

### CROSS REFERENCE TO RELATED APPLICATIONS

This non-provisional patent application claims priority to U.S. provisional patent application Ser. 62/914,800, filed Oct. 14, 2019, for all purposes. The disclosure of that provisional patent application is incorporated herein by reference, to the extent not inconsistent with this disclosure.

### BACKGROUND

### Field of the Invention

This invention relates generally to apparatus and methods for cutting, milling and/or grinding, namely removing, the body or surface of hard natural or man made materials such as for example, but not limited to natural rock, concrete, steel reinforced concrete, bitumen/asphalt, metals, wood, and soil and rock filled soil.

Applications for such apparatus and method include, but are not limited to general excavation, tunneling, trenching, surface preparation, demolition, and road works.

### SUMMARY OF THE INVENTION

Apparatus and methods embodying the principles of the present invention comprise certain embodiments of hardened material cutting bits, preferably PDC (polycrystalline diamond composite) cutting bits, mounted in bit holders, the bit holders mounted on the periphery of a circular cutting disc, drum, or blade, which may be referred to as a tool core; the cutting disc, drum or blade comprising a part of cutting, grinding and/or milling equipment, and methods of use of same. The circular cutting disc or tool core rotates to move the cutting bits into the material being cut. In a presently preferred embodiment, PDC bits or inserts are mounted in the bit holders, which are in turn mounted around the outer periphery or circumference of the cutting tool core. The bit holders comprise certain design principles which enable efficient mounting onto the tool core, and removal therefrom, namely mounting into bit holder pockets on the periphery of the tool core. The bit holders may be mounted either singly, or first mounted in multi-bit holder crown segments, which are then attached to the periphery of the tool core by bolting or similar means. The manner of mounting of the bit holders, whether mounted individually or in multi-bit holder crown segments, eases removal/replacement when needed.

### BRIEF DESCRIPTION OF THE DRAWINGS

FIGS. 1-3 show various bit holder/disk (or tool core) mounting arrangements.

FIG. 4 is a perspective view of the cutting bit and bit holder arrangement, in turn mounted on a tool core (only a section of the tool core being shown).

FIG. 5 is a side view of the cutting bit and bit holder arrangement shown in FIG. 4.

FIG. 6 is a cross section view illustrating further details of the cutting bit.

FIG. 7 is a perspective view of a cutting tool, showing the various elements of the invention.

FIGS. 8-10 are various views of a bit holder comprising a single cutting bit.

FIGS. 11-13 are various views of a bit holder comprising dual cutting bits.

FIGS. 14 and 15 are exploded and assembled views of the bit holder/tool core.

FIG. 16 is a perspective view of a tool core and bit holder arrangement, with the bit holders individually placed on the tool core.

FIG. 17 is a perspective view of multiple bit holders assembled into a crown segment, which is then mounted to a tool core as a whole group.

### DESCRIPTION OF CERTAIN PRESENTLY PREFERRED EMBODIMENTS

It is to be understood that the apparatus and method of the present invention may be used in all “cutting” and “milling” operations, as those terms may be referred to in general use.

The term “cutting” may be used when removal of a thin strip of material is described, and “milling” when larger volume over larger contact surface is removed at once. The transition from such “cutting” to “milling” is not precisely defined.

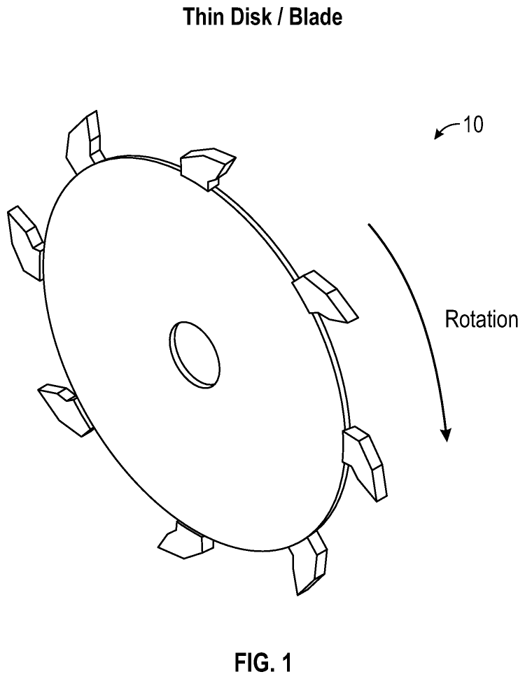

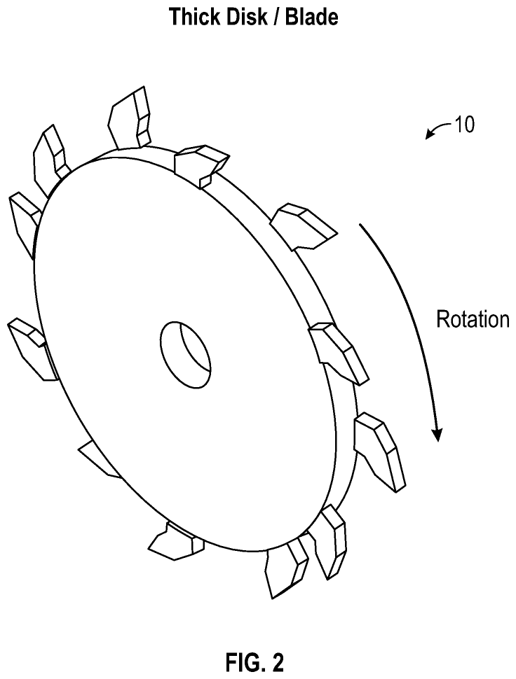

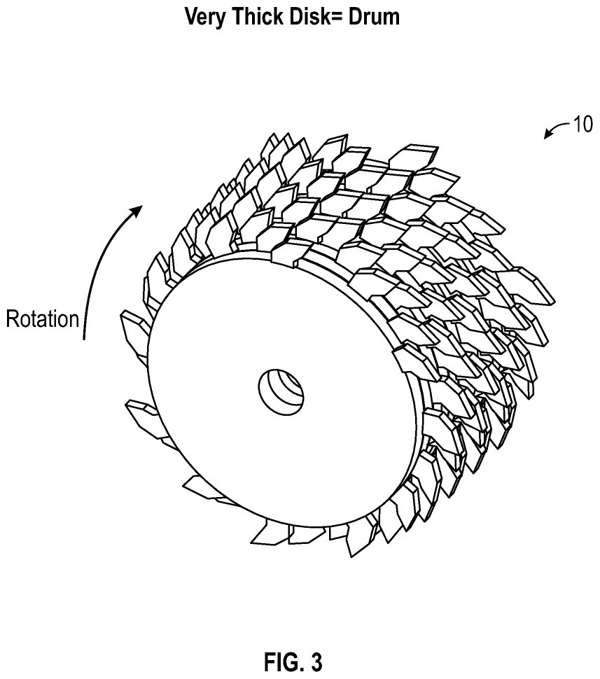

FIG. 1 shows a blade or tool core configuration with teeth or cutting bit assemblies mounted on a relatively thin disk (tool core), the tool core and cutting bit combination referred to generally as element 10. FIG. 2 shows a configuration with cutting bits mounted on a relatively thicker disk (tool core). FIG. 3 shows a very thick disk/drum with teeth mounted across the width of the disk/drum. The present invention may be used in any of these configurations. The term “disk” as used in connection with FIGS. 1-3 means “tool core.” The direction of rotation of tool core 20 is shown in FIGS. 1-3. This direction of rotation results in the direction of movement of the bit holders, as noted in the following drawings.

The Tool Core, Bit Holder, and Cutting Bit

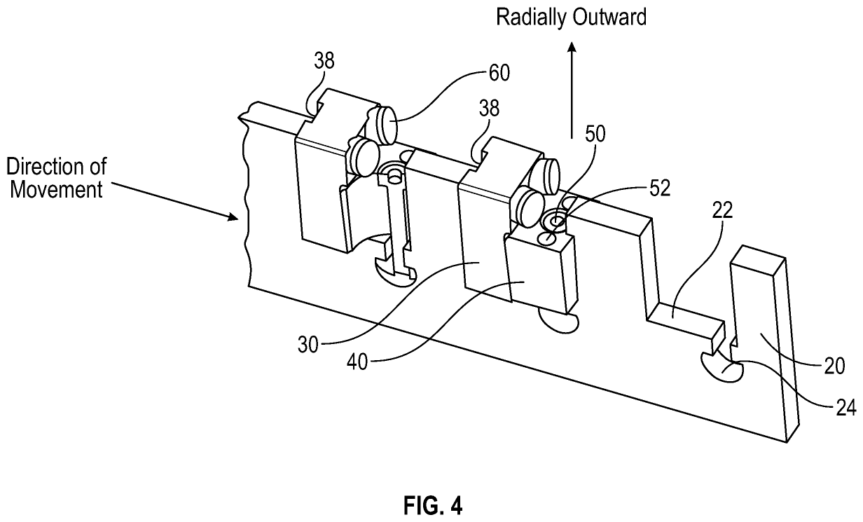

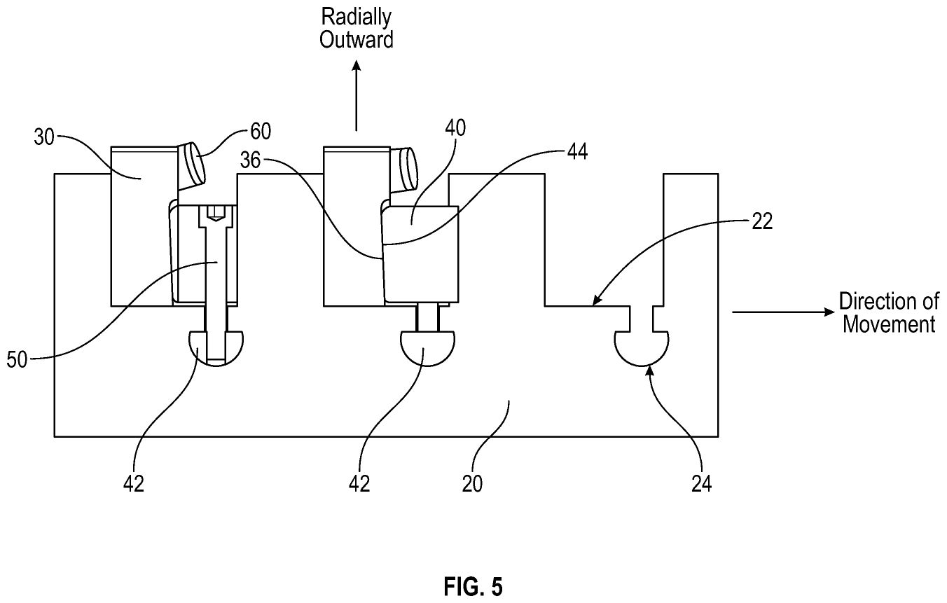

In the following figures, the direction of movement of the bit holders and related elements are shown. FIGS. 4 and 5 are perspective and side views showing certain details of these elements; further detail is shown in later figures and accompanying written description.

Referring particularly to FIGS. 4 and 5, a plurality of bit holder pockets 22 are arranged around the periphery of circular tool core 20 (it being understood that only a portion or segment of circular tool core 20 is shown in these figures). Anchor pockets 24 are formed in a lower portion of bit holder pockets 22.

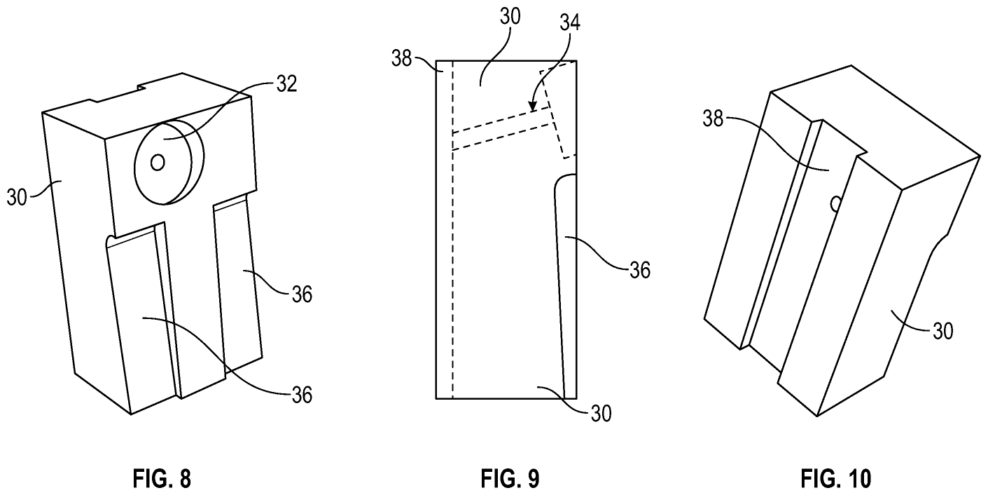

Bit holders 30 are positioned in bit holder pockets 22. A fastening wedge 40 also fits into bit holder pocket 22, preferably in front of bit holder 30 relative to the direction of movement of bit holder 30. A wedge anchor 42 fits into anchor pocket 24, and has a threaded hole to receive a threaded fastener 50, which may be a fastening screw, which extends through fastening wedge 40 and is tightened into wedge anchor 42. A section view of a fastening wedge 40, fastening screw 50, and wedge anchor 42 are noted in FIG. 4. FIG. 5 is a side view of the elements shown in FIG. 4. As can be seen, bit holder 30 and fastening wedge 40 have mating inclined cuts 36 (in bit holder 30) and inclined face 44 (in wedge anchor 40), such that with no radially outward movement of fastening wedge 40 being possible (fastening wedge 40 being fixed in bit holder pocket 22 by fastening screw 50 engaged with wedge anchor 42), and bit holder 30 is held radially in place. A locating groove 38 on the trailing or back side of bit holder 30 receives tool core 20 and holds bit holder 30 from any side-to-side movement. With the foregoing elements (locating groove 38 engaging tool core 20; and fastening wedge 40 preventing any forward or radially outward movement), it can be readily understood that with fastening wedge 40 held securely in place, bit holder 30 cannot move in bit holder pocket 22. Note that FIGS. 8-10, along with the accompanying description, give additional details of the structure of bit holders 30 and related components.

Although fastening wedge 40 is shown positioned in front of bit holder 30, it is understood that in an alternative embodiment fastening wedge 40 may be positioned behind bit holder 30, with the placement of inclined cuts 36 and inclined face 44 and locating grooves 38 moved accordingly.

Bit holder 30 can be assembled to tool core 30 by first fitting it into bit holder pocket 22 such that locating groove 38 engages tool core 20. Fastening wedge 40 can then be fitted into bit holder pocket 22 from one side of tool core 20. With wedge anchor 42 put into place in anchor pocket 24, threaded fastener (fastening screw) 50 can then be inserted and screwed together with wedge anchor 42, locking the assembly in place. It can be further understood that removal of threaded fastener 50 permits fastening wedge 40 to be removed, thus freeing bit holder 30 for removal/replacement as needed.

One or more cutting bits 60, which in a preferred embodiment comprise PDC (polycrystalline diamond composite) cutters, are mounted on bit holders 30, by means known in the relevant art. It is understood that other types of hardened cutting materials could be used for cutting bits 60, such as hardened steel; carbide; natural or synthetic rock material; or other materials known in the cutting art.

The direction of rotation of the tool core 20, hence direction of movement of the bit assembly, namely the bit holder 30, cutting bit 60, etc. is noted in the figures. References to “front” or “rear” or related terms are in relation to this direction of movement; e.g. “rear” is the trailing edge or surface, “front” being the leading edge or surface.

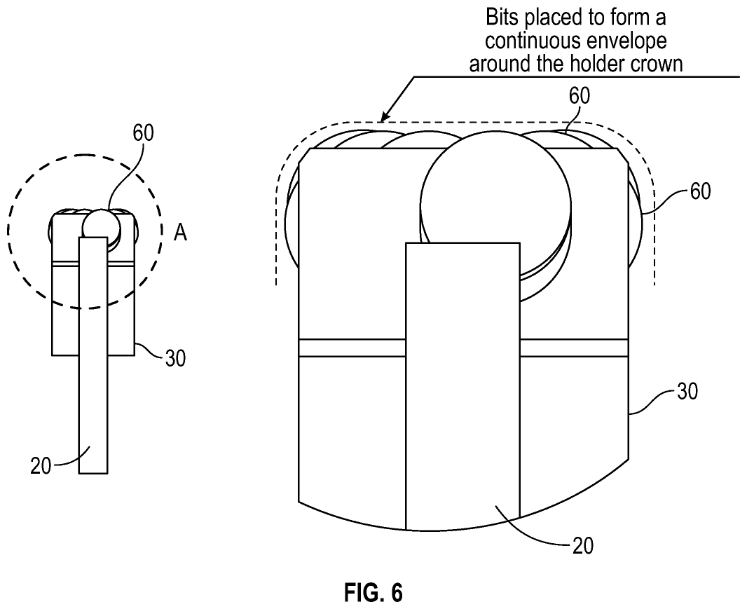

The placement of individual cutting bits or bit holders is noted. Bit holders 30 are machined and then placed around the periphery of tool core 20 preferably in a certain geometrical pattern whereby each cutting bit 60 cuts its own groove in the material being cut, and these grooves are positioned relative to each other so the material removal is even across the cross-section of the cut and contact of steel bit holders 30 with the cut material is minimised. One exemplary placement is shown in FIG. 6, which is a view of the leading or front side of bit holder 30 with cutting bits 60 mounted thereon.

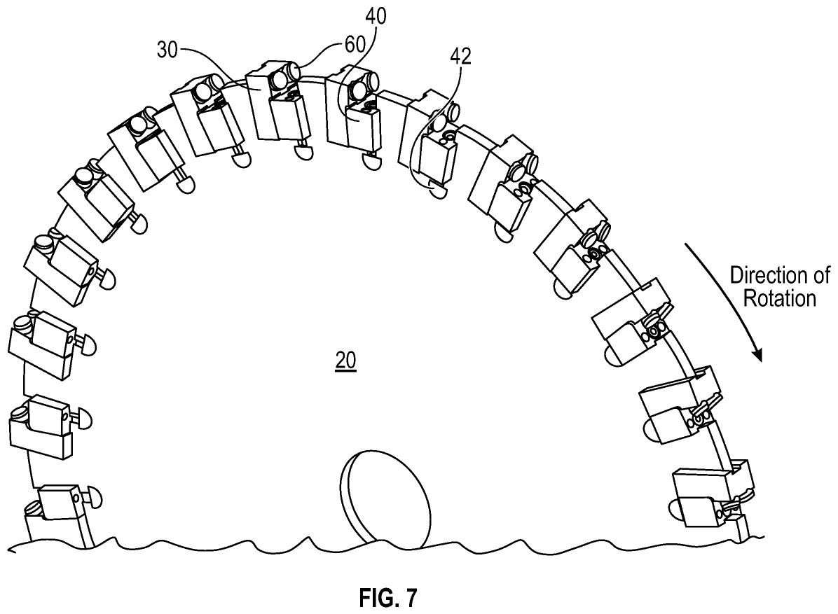

FIG. 7 is a perspective view of various elements of the cutting tool of the present invention. A segment of tool core 20 is shown, with bit holder 30 with attached cutting bits 60, fastening wedges 40, and wedge anchors 42 all shown.

Single Bit Holder

FIGS. 8-10 show various views and additional structural details of bit holder 30, in an embodiment comprising a single bit seat 32 and single cutting bit 60. Cutting bit 60, which may be a PDC bit or other suitable bit material, may be fit and attached to bit holder 30, namely in bit seat 32, by means known in the relevant art. Bit holder 30 preferably has a vent hole 34 therethrough, extending from the bit seat 32 to the rear face of bit holder 30. Inclined cuts 36 in bit holders 30 interact with mating inclined face 44 in fastening wedges 40, described in more detail below, to yield a secure fastening of bit holder 30 in bit holder pocket 22 of tool core 20. A locating groove 38 in the rear face of bit holder 30 receives tool core 20 in the rearward part of bit holder pocket 22, further providing stability to the mounting of bit holder 30 within bit holder pocket 22.

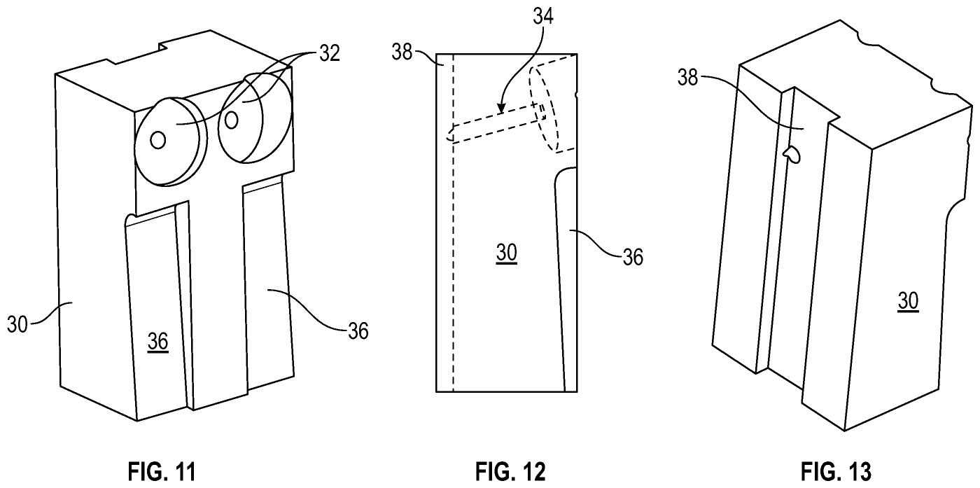

FIGS. 11-13 show a bit holder 30 comprising two bit seats 32, which will receive two PDC bits (or bits of other suitable material), as can be understood. It is to be understood that the present invention comprises any number of bit seats 32 and bits.

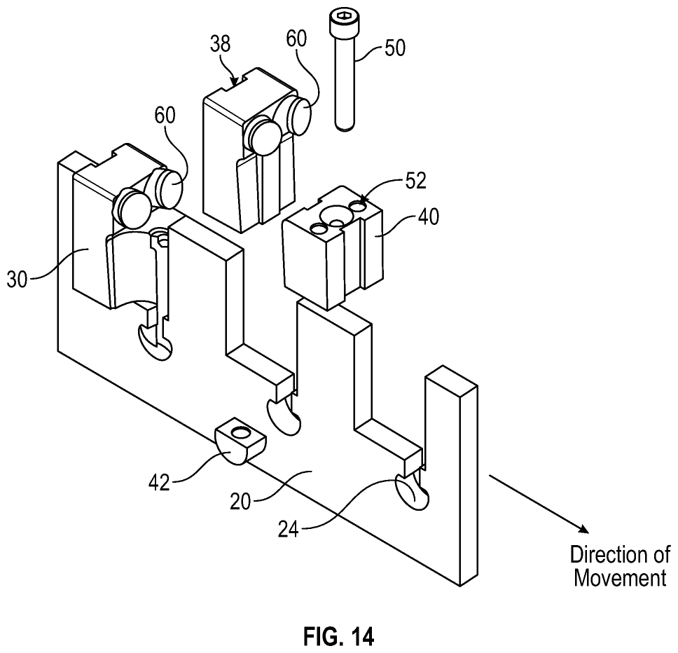

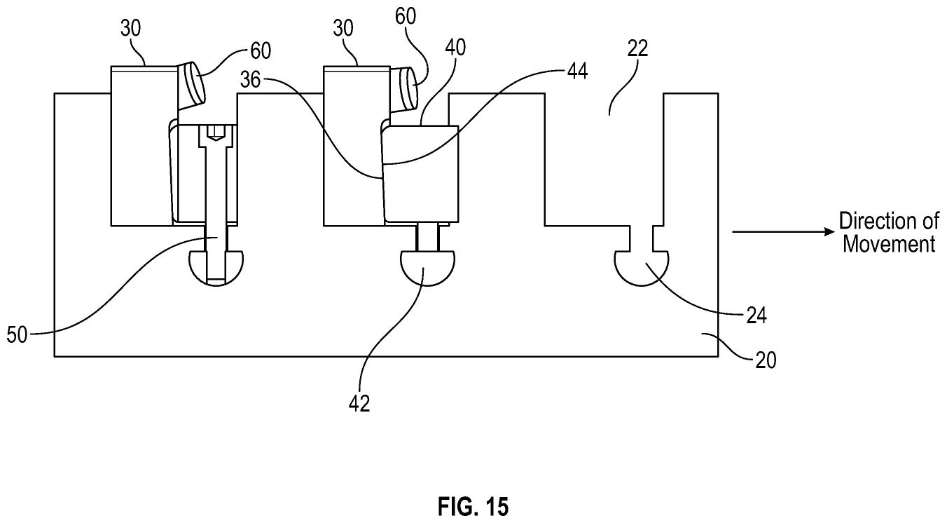

FIGS. 14 and 15 show further detail of an exemplary embodiment of the various elements mounted on tool core 20; reference is made to the foregoing description. It is understood that only a segment of tool core 20 is shown in FIGS. 14 and 15. Note that an extraction thread 52 may be provided to aid in removal of threaded fastener 50 (fastening screw). When assembled, the mating angled cuts 36 of bit holder 30 and angled face 44 of fastening wedge 40 hold the assembly firmly in place. Threaded fastener 50 threadably engages wedge anchor 42 and is tightly screwed together, which holds fastening wedge firmly in place.

I. Tool Core Design

a) Individual Bit Holder Placement

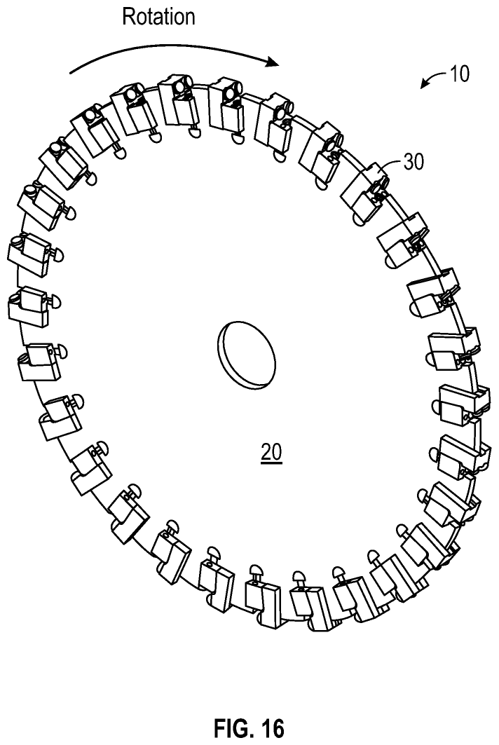

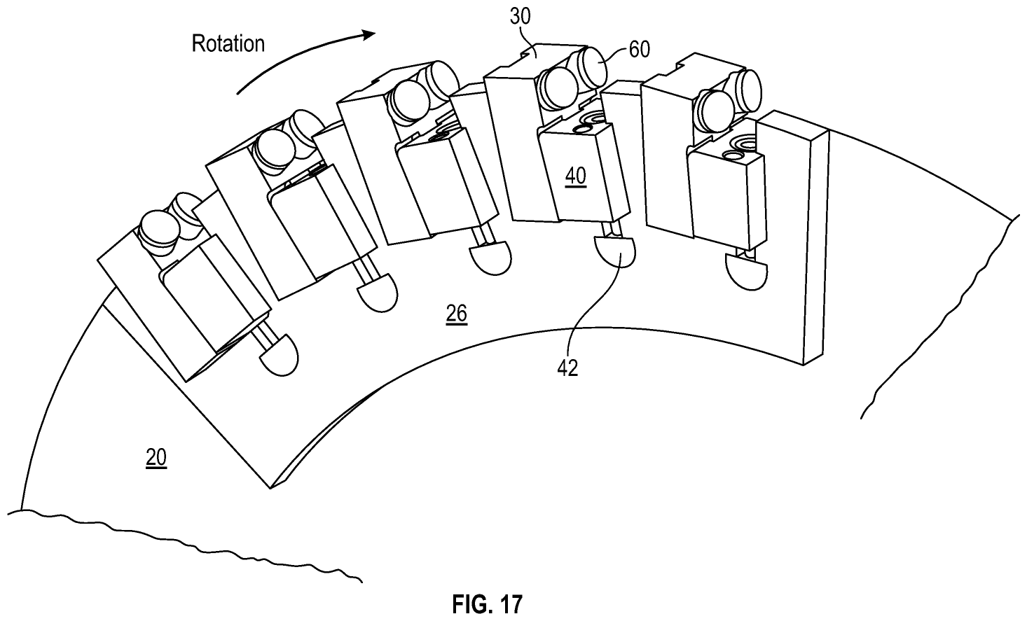

FIGS. 16 and 17 show alternative mounting arrangements for bit holders 30 onto tool core 20. In FIG. 16, bit holders 30 are individually mounted on tool core 20, each bit holder 30 positioned within a bit holder pocket 22 arranged around the periphery of tool core 20.

In FIG. 17, a plurality of bit holders 30 are mounted in a curved or arcuate segment, denoted as crown segment 26, which has a curvature generally corresponding to that of the desired tool core diameter. As can be seen, crown segment 26 comprises a plurality of bit holder pockets 22, along with anchor pockets 24, wedge anchors 42, etc. A plurality of crown segments 26 with attached bit holders can then be attached to the periphery of a tool core 20 by bolting or other means.

### CONCLUSION

While the preceding description contains many specificities, it is to be understood that same are presented only to describe some of the presently preferred embodiments of the invention, and not by way of limitation. Changes can be made to various aspects of the invention, without departing from the scope thereof.

Therefore, the scope of the invention is to be determined not by the illustrative examples set forth above, but by the appended claims and their legal equivalents.

I claim:

1. An apparatus, comprising:
a circular tool core having a plurality of bit holder pockets arranged around the periphery of said circular tool core, each bit holder pocket further comprising an anchor pocket;
a plurality of bit holders disposed in said bit holder pockets, each of said bit holders comprising a locating groove in a face thereof, said locating groove sized to receive said tool core, each of said bit holders further comprising an inclined cut in a face;
a fastening wedge disposed in said bit holder pocket, said fastening wedge comprising an inclined face corresponding to said inclined cut in said face of said bit holder;
a wedge anchor disposed in said anchor pocket; and
a threaded fastener extending through said fastening wedge and engaging mating threads in said wedge anchor.

2. The apparatus of claim 1, wherein:
said locating groove is disposed in a rear face of said bit holder, and said inclined cut is disposed in a forward face of said bit holder;
said fastening wedge is disposed in said bit holder pocket forward of said bit holder, and said inclined face is a rear face of said fastening wedge, and engages said inclined cut on said forward face of said bit holder; and
said bit holder comprises one or more cutting bits disposed thereon.

3. The apparatus of claim 2, wherein said one or more cutting bits are polycrystalline diamond composite cutting bit.

4. The apparatus of claim 3, wherein said one or more cutting bits comprise two or more cutting bits.

5. The apparatus of claim 2, wherein said bit holder comprises one or more extractor screws.

6. An apparatus, comprising:
a circular tool core having a plurality of bit holder pockets arranged around the periphery of said circular tool core, each bit holder pocket further comprising an anchor pocket;
a plurality of bit holders disposed in said bit holder pockets, each of said bit holders comprising a locating groove in a rear face thereof, said locating groove sized to receive said tool core, each of said bit holders further comprising an inclined cut in a forward face thereof, each of said plurality of bit holders comprising one or more cutting bits disposed thereon;
a fastening wedge disposed in said bit holder pocket forward of said bit holder, said fastening wedge comprising an inclined rear face corresponding to said inclined cut in said forward face of said bit holder;
a wedge anchor disposed in said anchor pocket; and
a threaded fastener extending through said fastening wedge and engaging mating threads in said wedge anchor.

7. The apparatus of claim 6, wherein said one or more cutting bits are polycrystalline diamond composite (PDC) cutting bits.

8. The apparatus of claim 7, wherein said bit holder comprises one or more extractor screws.

9. An apparatus, comprising:
one or more curved crown segments having a plurality of bit holder pockets arranged around the periphery of said curved crown segment, each bit holder pocket further comprising an anchor pocket;
a plurality of bit holders disposed in said bit holder pockets, each of said bit holders comprising a locating groove in a rear face thereof, said locating groove sized to receive said crown segments, each of said bit holders further comprising an inclined cut in a forward face thereof, each of said plurality of bit holders comprising one or more cutting bits disposed thereon;
a fastening wedge disposed in said bit holder pocket forward of said bit holder, said fastening wedge comprising an inclined rear face corresponding to said inclined cut in said forward face of said bit holder;
a wedge anchor disposed in said anchor pocket;
a threaded fastener extending through said fastening wedge and engaging mating threads in said wedge anchor; and
a circular tool core,
wherein said one or more crown segments are attached to the periphery of said circular tool core.

10. The apparatus of claim 9, wherein said one or more cutting bits comprise polycrystalline diamond composite (PDC) cutting bits.
